(19) United States
(12) Patent Application Publication
(10) Pub. No.: US 2011/0103721 A1
(43) Pub. Date: May 5, 2011

(54) BAG HAVING SEALABLE GUSSETS

(76) Inventors: GARY SARGIN, Green Bay, WI (US); Mark Jansen, North Charleston, SC (US)

(21) Appl. No.: 12/947,245

(22) Filed: Nov. 16, 2010

Related U.S. Application Data
(63) Continuation of application No. 12/774,792, filed on May 6, 2010, now abandoned.
(60) Provisional application No. 61/178,547, filed on May 15, 2009.

(30) Foreign Application Priority Data
May 5, 2010 (US) PCT/US10/33698

(51) Int. Cl. B65D 30/20; B31B 1/14

(52) U.S. Cl. 383/120; 493/227

(57) ABSTRACT

A bag and a method for making a bag, wherein the bag has a first panel, a second panel and side gussets, wherein openings extend through the first panel and through respective first sections of side gussets adjacent to the first panel, a sealing flap portion has adhesive material thereon, further adhesive material on the first panel, portions of the further adhesive material passing through the openings and onto respective second sections of the side gussets adjacent to the second panel, the bag is foldable to form a folded first panel, and the further adhesive material being folded with the folded first panel to provide an adhesive-to-adhesive seal, wherein a portion of the seal extends into the openings to adhere to the portions of the further adhesive material on the respective second sections of the side gussets.

### CROSS REFERENCE TO RELATED APPLICATION

The present application is a Continuation Application of U.S. application Ser. No. 12/774,792, Filed May 6, 2010 (Attorney Docket E4919-00181) which claims the benefit of U.S. Provisional Patent Application No. 61/178,547 filed May 15, 2009 (Attorney Docket E4919-00143).

### FIELD OF THE INVENTION

The present invention relates to a bag and method of making the same, wherein gussets of the bag are captivated through the use of heat-reactivated adhesive.

### BACKGROUND

U.S. Pat. No. 5,048,692 discloses a re-closable bag having a re-closable primary closure with interlocking sides. After closure, the bag is folded over, and a sealing flap covers the folded over portion of the bag to maintain the bag in its sealed and folded over configuration.

U.S. Pat. No. 5,195,829 discloses a bag in which the top has a rupturablex seal formed from a thermoplastic adhesive material, wherein the seal ruptures to allow the top to open and form a vent during heating of the bag and its contents.

U.S. Pat. No. 7,237,953 discloses a bag having a reclosable seal constructed with a closure mechanism, for example, a slide fastener or zipper.

### SUMMARY OF THE INVENTION

The invention relates to a method of making a tube into a stepped bag, the tube being foldable and having a first panel, a second panel and side gussets, wherein the method includes: slitting the tube where the side gussets join the second panel to provide a sealing flap; slitting the tube where the side gussets join the first panel to provide a slit portion of the first panel, followed by forming openings through the first panel and removing at least a portion of the slit portion of the first panel and removing portions of the side gussets; applying a heat-activated first adhesive material on the sealing flap; and applying a heat-activated second adhesive material on the tube, wherein; (a) the second adhesive material and the first adhesive material comprise the same adhesive material or comprise different adhesive materials, (b) a first portion of the second adhesive material is applied on the first panel, and is adapted to engage the first adhesive material while the tube is folded and while heat is applied, for forming a heat activated first adhesive-to-adhesive seal, and (c) a second portion of the second adhesive material extends through the openings and on the side gussets, and is adapted to engage the first portion of the second adhesive material while the tube is folded and while heat is applied for forming a heat activated second adhesive-to-adhesive seal for covering the openings and to bond the side gussets to the first panel.

A stepped bag of the invention includes: a tube having a first panel, a second panel and side gussets; the second panel having a sealing flap; a heat activated first adhesive material on the sealing flap; a foldable portion of the tube; a first portion of a second adhesive material on the foldable portion of the tube, wherein the first portion of the second adhesive material is adapted to form a heat activated first adhesive-to-adhesive seal with the first adhesive material on the sealing flap while the tube is folded and heat is applied, and wherein the second adhesive material and the first adhesive material comprise the same adhesive material or comprises different adhesive materials; openings through the first panel; a second portion of the second adhesive material extending in the openings and on the side gussets; and the tube is foldable to fold the second adhesive material on itself while heat is applied, for forming a heat activated second adhesive-to-adhesive seal with the second portion of the second adhesive material to cover the openings and to bond the side gussets to the first panel.

### BRIEF DESCRIPTION OF THE DRAWINGS

Embodiments of the invention will now be described by way of example with reference to the accompanying drawings.

FIG. 1 is an isometric view of a woven bag embodiment.

FIG. 2 is an elevation view of a panel of a stepped bag with slits along side edges.

FIG. 3 is an elevation view of another panel of the stepped bag having slits, fold lines and openings through both the panel and sections of side gussets.

FIG. 4 is a view similar to FIG. 3 with the panel folded down.

FIG. 5 is a view similar to FIG. 4 with a portion of the panel removed.

FIG. 6 is a view similar to FIG. 5 with a sealing flap portion and adhesive materials applied to the stepped panel and the sealing flap portion.

FIG. 7 is an elevation view of a folded and sealed bag.

### DETAILED DESCRIPTION

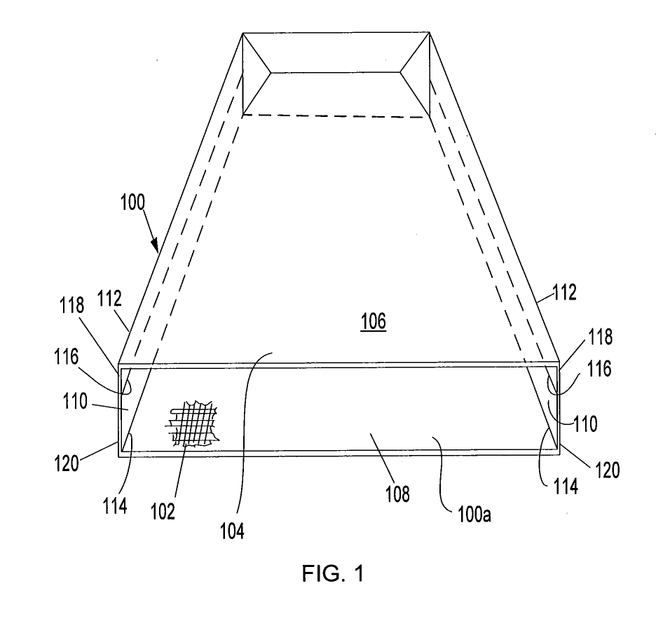

FIG. 1 discloses a bag 100 having an open end 100a encircled by a first panel 106, a second panel 108 and sides of the bag provided by two gusseted side panels 110, hereafter referred to as side gussets 110. The first panel 106 refers to a first panel of the bag 100 while the second panel 108 refers to a back panel of the bag 100. Alternatively, the first panel of the bag 100 is a back panel of the bag 100 while the second panel 108 refers to a front panel of the bag 100.

The side gussets 110 join the first panel 106 along respective longitudinal edge folds 112. The side gussets 110 join the second panel 108 along respective longitudinal edge folds 114. The side gussets 110 have longitudinal folds 116 or creases. Respective first sections 118 of the side gussets 110 are adjacent to the first panel 106. Respective second sections 120 of the side gussets 110 are adjacent to the second panel 108. The side gussets 110 are folded along the folds 116. The first sections 118 and the second sections 120 fold inwardly along the folds 116, and are in an inwardly folded orientation between the first panel 106 and the second panel 108 while the bag 100 is flat. Each side gusset 110 is adapted to unfold outwardly from between the first panel 106 and the second panel 108 to expand the bag interior.

An embodiment of the bag 100 is formed as a laminated tube 100 that has a woven inner layer 102, a portion of which is illustrated to comprise a tight basket weave of thin, flexible, elongated strips of a polymeric material, for example, polypropylene. The inner layer 102 advantageously comprises a woven seamless tube that is highly flexible due to the weave. The laminated tube 100 has at least one outer layer 104 of a printable nonwoven polymeric material, for example, polypropylene film that is capable of being printed with graphics using water based pigments or solvent based pigments. In an embodiment of the invention, the outer layer 104 is reverse printed on an inside surface of a first polypropylene film. A second layer of polypropylene film is laminated to the first polypropylene film, with the printed surface between the first and second layers of polypropylene film. After printing the outermost layer 104, each outer layer 104 and the woven inner layer 102 are laminated, for example, by applying a solventless adhesive material or solvent based adhesive material between the layers to be laminated, and applying heat and pressure to laminate each outer layer 104 and the inner layer 102 and form the continuous laminated tube 100. Alternative embodiments of the bag 100 are fabricated with one or more nonwoven polypropylene films to provide a nonwoven inner layer 102 and a nonwoven outer layer 104.

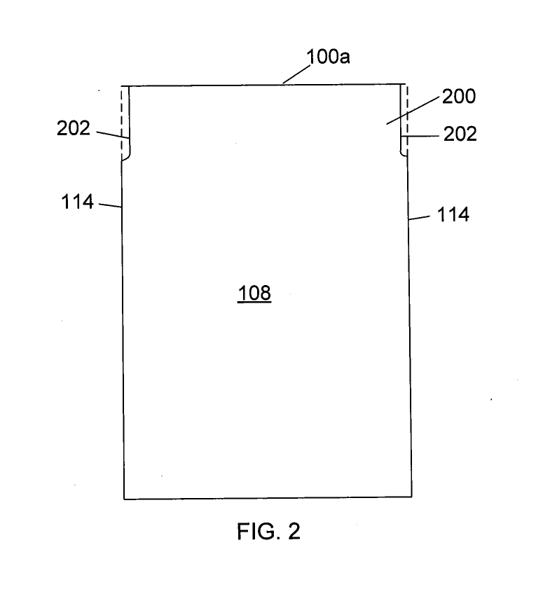

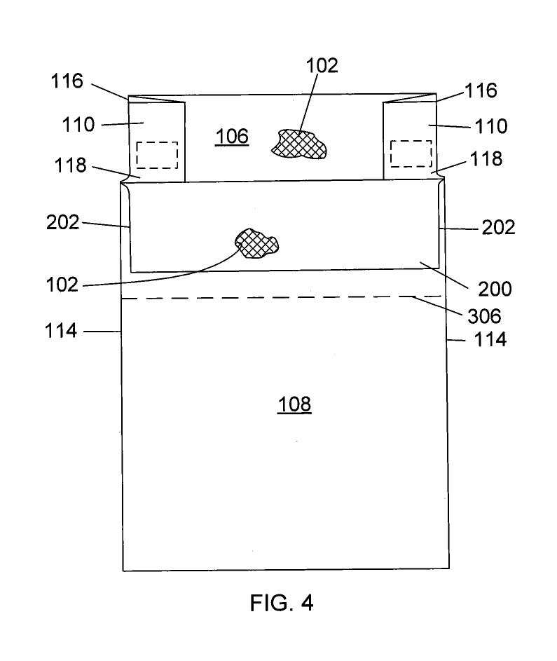

Embodiments of the bag 100 are manufactured for use with existing equipment for filling the bag 100 with contents and thereafter for use with existing equipment for closing and sealing the bag 100. FIG. 2 discloses a stepped bag 100 formed with a slit portion 200 of the second panel 108 adjacent to the bag end 100a. The slit portion 200 of the second panel 108 has first corresponding slits 202 along side edges thereof. The first corresponding slits 202 separate the slit portion 200 of the second panel 108 from the side gussets 110. FIG. 4 discloses the panel 108 having the slit portion 200 free of the side gussets 110 and capable of being foldable by pivoting downward and away from the bag end 100a and downward and away from the first panel 106, as disclosed by FIG. 4.

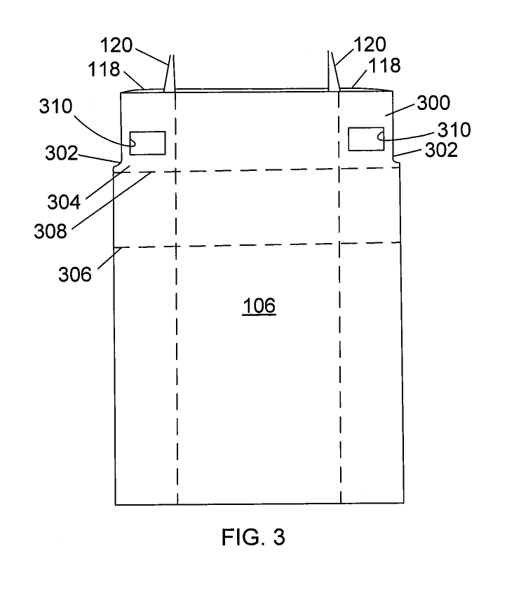

FIG. 3 discloses a slit portion 300 of the first panel 106 having second corresponding slits 302 along side edges thereof, wherein the second corresponding slits 302 are slitted along the longitudinal edge folds 112, FIG. 1, to separate the slit portion 300 from the side gussets 110. For example, the first corresponding slits 202 are simultaneously manufactured with the second corresponding slits 302 while the bag 100 is flat in FIG. 2. Slitting is accomplished by cutting along the longitudinal edge folds 114 or by punching to remove material along the longitudinal edge folds 114. The slits 202 and 302 extend from the open end 100a a limited distance, for example, a limited distance of 3.81 centimeters or 1.5 inches.

Further, FIG. 3 discloses pivoting the second sections 120 of the side gussets 110 away from the respective first sections 118. The slit portion 200 of the second panel 108 is behind the pivoting second sections 120. For this reason, pivoting the second sections 120 will cause the slit portion 200 of the second panel 108 to move away with the pivoting second sections 120. Alternatively, the second panel 108 is pivoted downward.

FIG. 3 discloses a process of extending openings 310 through the first section 304 of the first panel 106 of the bag 100, and further extending the openings 310 through respective first sections 118 of the side gussets 110, wherein the first sections 118 are adjacent to the first panel 106. A preferred embodiment of the process includes, but is not limited to, pivoting the second sections 120 of the side gussets 110 away from the respective first sections 118 while forming the openings 310 with tooling, either manual or automated tooling. Alternatively, the tooling itself can engage and pivot the second sections 120 of the side gussets 110 away from the respective first sections 118 while forming the openings 310 with the tooling. For example, each of the first sections 118 of the side gussets 110 is 6.985 cm. wide or 2.75 inches wide. Further, for example, each of the openings 310 is disclosed as having a rectangular shape measuring 1.905 cm. by 2.54 cm. wide, or 0.75 inches by 1 inch wide. However, the openings 310 can have other shapes determined by the shapes of the tooling, wherein the tooling operates by punching, severing, cutting, sawing or drilling to extend the openings 310 simultaneously through both the first panel 106 and the respective first sections 118 of the side gussets 110. After forming the openings 310 the bag 100 is collapsed or folded to a flat configuration in preparation for further manufacturing operations.

FIG. 3 discloses the first panel 106 having an upper horizontal first section 304 across the width of the bag 100 and adjacent to the bag end 100a. A fold line 308 extends across the width of the bag 100 and along a junction between the first section 304 and a second section 306. FIG. 3 discloses a horizontal second section 306 adjacent to the first section 304. According to an embodiment of the invention, the bag 100 is foldable on itself along the fold line 308. The fold line 308 encircles the bag 100 to extend across the first panel 106, across the second panel 108, and across the side gussets 110. The fold line 308 is located below the slits 202, 302 to avoid intersecting the slits 202, 302. According to an embodiment of the invention, the bag 100 is folded along the fold line 308 without a crease. According to another embodiment of the invention, a crease along the fold line 308 enables the bag 100 to fold on itself along the crease. While the bag 100 is flat, a standard creasing apparatus manufactures the bag 100 with a permanent crease along the fold line 308 and across the first panel 106, the second panel 108 and the side gussets 110.

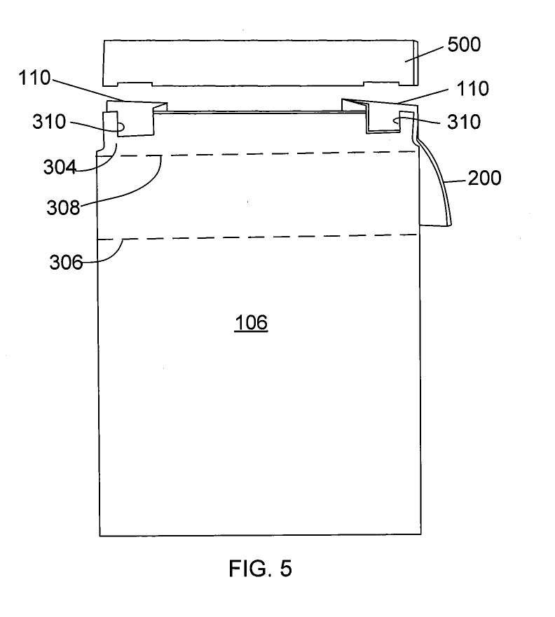

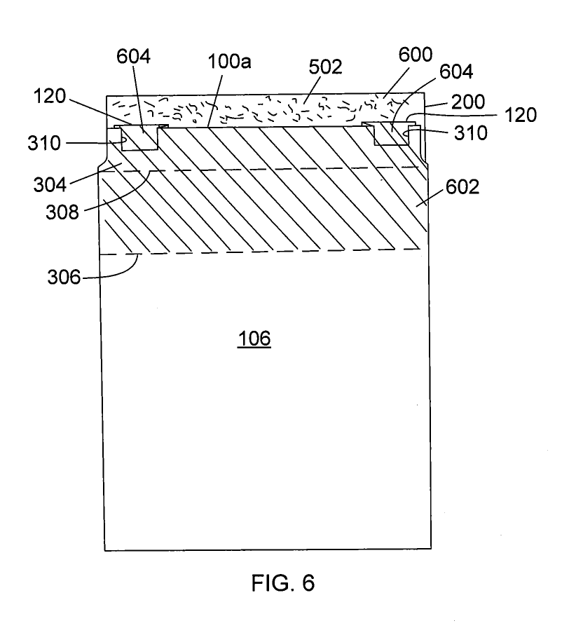

FIG. 6 discloses an embodiment of the bag 100 is made with a sealing flap portion 502 for use by existing equipment that fill a bag with contents and thereafter close and seal the bag with a sealing flap. FIG. 5 discloses a process of removing a removable portion 500 of the first panel 106 while the slit portion 200 of the second panel 108 is folded downward and away as in FIG. 4. Further, the slit portion 200 of the second panel 108 is folded downward and away from the side gussets 110. The process of removing the removable portion 500 of the first panel 106 is performed to expose part of the second panel 108, disclosed in FIG. 6, as a sealing flap portion 502. Further, the process disclosed by FIG. 5 removes portions of the side gussets 110 together with the removable portion 500 of the first panel 106 to expose part of the second panel 108 as the sealing flap portion 502.

During manufacture of the bag 100, while the bag 100 is flat, FIG. 6 discloses a process of applying a first layer of a first adhesive material 600 on the sealing flap portion 502. Further FIG. 6 discloses applying a second layer of additional or further second adhesive material 602 wherein a first portion is on the first panel 106 of the bag 100, and wherein a second portion 604 of the adhesive material 602 passes through the openings 310 and onto the outer bag layer 106 of respective second sections 120 of the side gussets 110 adjacent to the second panel 108. The first adhesive material 600, the first portion of the second adhesive material 602 and the second portion 604 of the adhesive material 602 are applied, while the bag 100 is flat, by an adhesive material applicator including, but not limited to a roller, brush or spraying apparatus. The adhesive material 600, the adhesive material 602 and the portion 604 of the adhesive material 602 are applied simultaneously to attain manufacturing speed. The first adhesive material 600 and the second adhesive material 602 are applied as fluent compositions including emulsions or solutions constituted in a fluid including, but not limited to water or a chemical solvent. Then the first adhesive material 600 and the second adhesive material 602 are dried in a heated oven to drive off the fluent substances. The first adhesive material 600 and the further or second adhesive material 602 are the same material or, alternatively, are different materials, which are capable of forming moisture and water resistant, heat activated adhesive-to-adhesive seals.

The adhesive-to-adhesive seal is formed by heating the adhesive material 600 and the further adhesive material 602 to a melt flow temperature at which they attain a melt flow, adhesive state. The adhesive material 600 and the further adhesive material 602 have melt flow temperatures of about 300° F. maximum to avoid heating the polymeric material of the bag 100 to its melt flow temperature above the 300° F. threshold temperature. A suitable heat activated adhesive material 602 forms a heat activated adhesive-to-adhesive seal to itself. The heat activated adhesive material further includes, but is not limited to a thermoplastic (not thermosetting) adhesive material of waterborne adhesives acrylic based waterborne adhesives, waterborne polyurethane adhesive dispersions, or a combination thereof. The adhesive materials 600, 602 on the bag 100 has a coating weight of at least 10 lb./ream on each of opposing surfaces to form an adhesive-to-adhesive seal between the opposing surfaces of about 20 lb./ream coating weight. The adhesive materials 600, 602 are activated to an adhesive state by applying heat at a heat activation temperature below the heat activation temperatures of standard or traditional hot melt adhesives or solvent based adhesives that can seal traditional paper and polymer laminated bags without damaging the paper layers, but which exceed the softening point temperature T_{g} of polymeric bags 100 fabricated without paper layers. The standard or traditional hot melt adhesives cannot be combined with polypropylene bags 100 because the temperatures needed to activate the adhesives are destructive to the PP material structure.

Embodiments of the adhesive materials 600, 602 comprise, an aqueous dispersion of an adhesive material or a water based adhesive materials applied in liquid form and air dried or cured to a stable, non-adhesive state when air dried to ambient temperature. Further embodiments of the adhesive materials 600, 602 each are an acrylic based waterborne adhesive or a polyurethane dispersion adhesive, or a butyl, synthetic or natural rubber adhesive. Other embodiments of the adhesive materials 600, 602 include a polyurethane adhesive dispersed in water (PUD). A preferred embodiment is made up of 35 percent solids. It is applied at 1.75 grams/bag wet, assuming an 18″ wide bag, across the 3″ sealing area. The viscosity is adjusted to correspond with the mass flow rate of the preferred embodiments of an applicator apparatus and method, for example, a slot die applicator applying a stripe of the adhesive layers each of a viscosity of 800-1000 centipoises and a coating weight sufficient to form an adhesive-to-adhesive seal that will withstand bag tests to be described herein.

An embodiment of the adhesive materials 600, 602 for pinch sealing of PP woven bags 100 is comprised of synthetic polymer or co-polymer emulsions that are water- or solvent-based, including without limitation polyurethane dispersion adhesives, vinyls, acrylics, or other polymer or co-polymer emulsions, or may include natural or synthetic rubber-based adhesives, which are applied wet solubilized and then dried to a hardened state impervious to water and water vapor. Known application apparatus to use on a production line includes, but is not limited to spray applicators, wheels, or a slot die applicators. The adhesive materials 600, 602 form an adhesive-to-adhesive seal when activated to adhesive states by heat applied by a hot air jet or other thermal source at an elevated temperature up to about and less than about 300 degrees F. which is below the melting point temperature of the polymeric, polyolefin films and/or PP woven materials of the bag panels 106, 108 and the bag gussets 110 when present. Such adhesive materials 600, 602 provide adequate bond and adhesion to polyolefin films and/or PP woven materials, are FDA approved for non-direct food contact, and provide adequate sheer, peel and bond strengths to meet bag testing parameters to be described herein.

Two adhesive materials 600, 602 in particular are an acrylic based waterborne adhesive and a polyurethane dispersion adhesive. Each has an adhesive state activation temperature below 300° F., and below the softening point temperature T_{g} of the polymeric layers 102, 104 made of compostable polypropylene, for example.

An embodiment of the adhesive materials 600, 602 includes: a polyurethane adhesive dispersion of 35% solids in water, with a viscosity adjusted for application to the bags, for example, a viscosity of approximately or about 800-1000 centipoises for application by a slot die applicator, or less than about 800 centipoises for application by a spray applicator. The viscosity is varied or adjusted to obtain an optimum mass flow rate and attain a desired coating weight as need for application by a specific form of applicator. Adhesive 1623-63A, is available commercially from Bostik, Inc. Wauwatosa, Wis. 53226, USA, wherein the adhesives per se form no part of the present invention separate from being a structural component of the bags disclosed herein. The embodiments of adhesive materials 600, 602 as a structural component of the bags includes 1.75 grams adhesive material per bag applied wet, solubilized in water, assuming an 18 inch wide bag and a 3 inches wide stripe of adhesive on the bag, which is equivalent to 0.6 grams per bag dry or about 10.6 lbs per ream dry weight coating. Once the adhesive materials 600, 602 are applied, they must pass under a drying system to evaporate the water and dry the adhesive layers to a stable state impervious to water, water vapor and ambient temperatures.

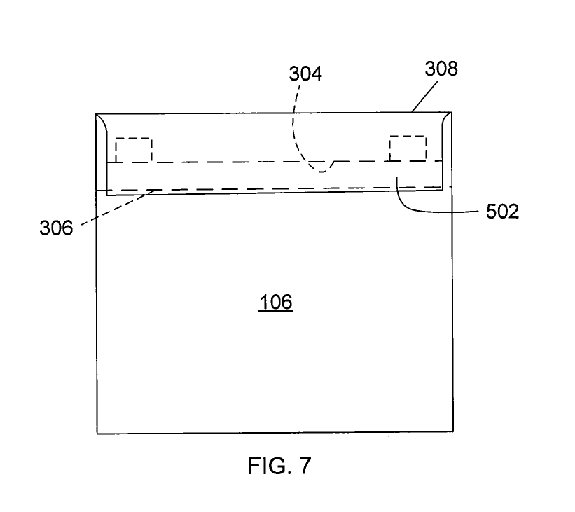

The foldable bag 100 is flattened by folding along its gusseted side panels 110 for shipping and handling, in preparation for shipment to a location where the bag 100 is opened at one end 110a and filled with contents. The adhesive materials 600, 602 are in their dry, solidified states during bag filling, and are moisture and water resistant, by which the adhesive materials 600, 602 avoid contamination of the bag contents. After the bag 100 has been filled with contents, the bag 100 is closed and sealed, according to a process described as follows, a heat source including, but not limited to heated air or a hot bar applies heat to activate the adhesive materials 600, 602 to their respective, heat-activatable adhesive states. While the adhesive materials 600, 602 are in their adhesive states, the source of heat is removed and the end 100a of the bag 100 is folded so the adhesive materials 600, 602 adhere, and then the bag 100 is pinched closed to hold the contents in the bag 100. Further, while the adhesive materials 600, 602 are in their adhesive states, the bag 100 is folded along the fold line 308, which folds the bag panel 106 on itself, wherein the bag sections 304 and 306 on the bag panel 106 fold toward each other with the adhesive materials 600, 602 therebetween. Pressure is applied against the bag sections 304, 306 of the folded bag 100, until an adhesive-to-adhesive seal forms by two layers of the adhesive material 600 that are between the bag sections 304 and 306. Further, by folding along the fold line 308, the sealing flap 502 is folded toward the bag section 306. Pressure is applied against the sealing flap 502 until an adhesive-to-adhesive seal forms by the layers of adhesive materials 600, 602 between the sealing flap 502 and the bag section 306, shown in FIG. 7. The adhesive-to-adhesive seal is established to seal the bag end 100a with the sealing flap portion 502. Further, the bag 100 is folded and sealed along the fold line 308.

In FIGS. 6 and 7, the adhesive material 602 when the bag 100 is folded along the fold line 608, extends through the openings 310 to contact the adhesive portions 604 on the second sections 120 of the side gussets 110. The heat activatable adhesive-to-adhesive seal adhesively bonds the second sections 120 of the side gussets 110 to the first panel 106, and avoid inadvertent leaking or unsealing of the bag 100 at the side gussets 110. Thereby, the side gussets 110 are constructed and arranged to be glued. The first section of the first panel is foldable upon itself to fold together with the foldable sealing flap portion, and wherein folding the first section of the first panel on itself folds the further adhesive material upon itself to form an adhesive-to-adhesive seal, the adhesive-to-adhesive seal covering and sealing the openings through both the first panel of the bag and the respective first sections of the side gussets.

In FIG. 7, the sealing flap portion 502 is foldable toward the first panel 106 to urge the adhesive material 600 on the sealing flap portion 502 into contact with the further adhesive material 602 on the first panel 106 of the bag 100. The heat activatable adhesive-to-adhesive seal between the sealing flap portion 502 and the first panel 106 holds the bag 100 in a folded configuration to seal the end 100a of the bag 100. Further, the bag 100 is adhesively held in the folded configuration after being filled and sealed, wherein the held folded configuration resists, and essentially prevents, inadvertent unfolding and opening the end of the filled bag to be caused by rough handling or by dropping the filled bag from an elevated height.

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Patents and patent applications referred to herein are hereby incorporated by reference in their entireties. Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A method of making a tube into a stepped bag, the tube being foldable and having a first panel, a second panel and side gussets, comprising:
slitting the tube where the side gussets join the second panel to provide a sealing flap;
slitting the tube where the side gussets join the first panel to provide a slit portion of the first panel, followed by forming openings through the first panel and removing at least a portion of the slit portion of the first panel and removing portions of the side gussets;
applying a heat-activated first adhesive material on the sealing flap; and
applying a heat-activated second adhesive material on the tube, wherein;
(a) the second adhesive material and the first adhesive material comprise the same adhesive material or comprise different adhesive materials,
(b) a first portion of the second adhesive material is applied on the first panel, and is adapted to engage the first adhesive material while the tube is folded and while heat is applied, for forming a heat activated first adhesive-to-adhesive seal, and
(c) a second portion of the second adhesive material extends through the openings and on the side gussets, and is adapted to engage the first portion of the second adhesive material while the tube is folded and while heat is applied for forming a heat activated second adhesive-to-adhesive seal for covering the openings and to bond the side gussets to the first panel.

2. The method of claim 1, comprising:
slitting the tube simultaneously where the side gussets join the second panel and where the side gussets join the first panel.

3. The method of claim 1, comprising:
slitting the tube while the tube is flat by slitting the tube simultaneously where the side gussets join the second panel and where the side gussets join the first panel.

4. The method of claim 1, comprising:
slitting the tube by punching to remove material along longitudinal edge folds where the side gussets join the second panel and by punching to remove material along longitudinal edge folds where the side gussets join the first panel.

5. The method of claim 1, comprising:
forming the openings through the first panel and through first sections of the side gussets adjacent the first panel; and
applying the second portion of the heat-activated second adhesive material in the openings and on second sections of the side gussets adjacent the second panel.

6. The method of claim 1, comprising:
creasing the bag to form a crease along which the bag is foldable.

7. A tube for a stepped bag comprising:
the tube having a first panel, a second panel and side gussets;
the second panel having a sealing flap;
a heat activated first adhesive material on the sealing flap;
a foldable portion of the tube;
a first portion of a second adhesive material on the foldable portion of the tube, wherein the first portion of the second adhesive material is adapted to form a heat activated first adhesive-to-adhesive seal with the first adhesive material on the sealing flap while the tube is folded and heat is applied, and wherein the second adhesive material and the first adhesive material comprise the same adhesive material or comprises different adhesive materials;
openings through the first panel; and
a second portion of the second adhesive material extending in the openings and on the side gussets; and
the tube is foldable to fold the second adhesive material on itself while heat is applied, for forming a heat activated second adhesive-to-adhesive seal with the second portion of the second adhesive material to cover the openings and to bond the side gussets to the first panel.

8. The tube for a stepped bag of claim 7 comprising:
the openings extending through the first panel and through first sections of the side gussets adjacent the first panel;
the side gussets comprise second sections adjacent the second panel; and
the second portion of the heat-activated second adhesive material is in the openings and on the side gussets comprising the second sections adjacent the second panel.

9. The tube for a stepped bag of claim 7 wherein the sealing flap comprises a portion of the second panel.

10. The tube for a stepped bag of claim 7, comprising:
the first panel and the side gussets being shorter than the second panel.

11. The tube for a stepped bag of claim 7 wherein the second adhesive material comprises the same material as the first adhesive material.

12. The tube for a stepped bag of claim 7 wherein the second adhesive material comprises a different material than the first adhesive material.

13. The tube for a stepped bag of claim 7 comprising:
a crease providing a fold line along which the tube is foldable.

14. The tube for a stepped bag of claim 7 wherein the openings are adjacent a top of the first panel.

15. A tube for a stepped bag comprising:
the tube having a first panel, a second panel and side gussets;
the tube being foldable along a fold line;
the first panel having adhesive material below the fold line;
a portion of the first panel extending above the fold line and having thereon adhesive material above the fold line;
the side gussets extending above the fold line and having thereon adhesive material above the fold line;
the second panel extending above the fold line and providing a sealing flap, and the sealing flap having thereon adhesive material above the fold line; and
the adhesive material below the fold line engaging the adhesive material above the fold line and forming an adhesive to adhesive seal therewith while the tube is folded along the fold line.

16. A method of making a tube into a stepped bag, the tube having a first panel, a second panel and side gussets, comprising:
slitting the tube at one end thereof at where first portions of the side gussets join the first panel, to provide a slit portion of the first panel;
slitting the tube at said one end thereof at where second portions of the side gussets join the second panel, to provide a sealing flap, and wherein the second portions of the side gussets are adjacent removable parts of the first portions of the side gussets;
removing the removable parts of the first portions of the side gussets;
removing at least a portion of the first panel and portions of the side gussets, to expose the sealing flap; and
applying heat-activated adhesive material above a fold line and below the fold line, wherein the fold line extends across the tube, and wherein the adhesive material above the fold line is adapted to engage the adhesive material below the fold line for forming a heat activated adhesive-to-adhesive seal, while the tube is folded along the fold line and while applying heat to heat-activate the adhesive material.
